(19) United States
(12) Patent Application Publication
(10) Pub. No.: US 2026/0178344 A1
(43) Pub. Date: Jun. 25, 2026

(54) APPARATUS, METHOD, AND COMPUTER PROGRAM PRODUCT FOR INITIATING PERFORMANCE OF ONE OR MORE PROGRAM SUBSIDIARY EXECUTION ACTIONS

(71) Applicant: ATLASSIAN PTY, LTD., Sydney (AU)

(72) Inventors: Abhinaya SINHA, Bengaluru (IN); Sathish Kumar Suresh MAHADEV, Bengaluru (IN); Binod Pankajakshy GANGADHARAN, Bengaluru (IN); James Francis NAVIN, Glenbrook (AU); Ugur TURAN, Ankara (TR); Simon Wai-Han CHAN, Canberra (AU)

(21) Appl. No.: 19/427,273

(22) Filed: Dec. 19, 2025

Related U.S. Application Data
(60) Provisional application No. 63/738,683, filed on Dec. 24, 2024.

(51) Int. Cl. G06F 9/445; G06F 3/04847

(52) U.S. Cl. CPC G06F 9/445; G06F 3/04847

(57) ABSTRACT

Apparatus, methods, and computer program products for initiating performance of one or more program subsidiary execution actions are provided. A method may include generating a program configuration selection interface component based at least in part on unconfigured program orchestration data, outputting the program configuration selection interface component for rendering to a program management interface of a computing device, identifying configured program orchestration data via the program configuration selection interface component, generating one or more program external service node links based at least in part on the configured program orchestration data, configuring an automated program subsidiary execution action engine based at least in part on the configured program orchestration data and one or more of the one or more program external service node links, initiating, using the automated program subsidiary execution action engine, performance of one or more program subsidiary execution actions.

### CROSS-REFERENCE TO RELATED APPLICATIONS

This application claims the benefit of U.S. Provisional Patent Application No. 63/738,683, filed Dec. 24, 2024, the entire contents of which are incorporated by reference herein.

### BACKGROUND

Various methods, apparatuses, and systems provide tools for plan, execute, address, resolve, initiate, cause, and monitor program subsidiary execution actions and/or interface components in program action orchestration operation environments. Applicant has identified a number of deficiencies and problems associated with tools for effectively, reliably, and securely managing program subsidiary execution actions and interface components in a program action orchestration operation system. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a program action orchestration operation system, one or more interface components, such as a program configuration selection interface component.

In accordance with some exemplary embodiments of the present disclosure, an example apparatus for initiating performance of one or more program subsidiary execution actions is provided. In some embodiments, the apparatus may comprise at least one processor and at least one memory including program code. In some embodiments, the at least one memory and the program code are configured to, with the at least one processor, cause the apparatus to generate a program configuration selection interface component based at least in part on unconfigured program orchestration data. In some embodiments, the at least one memory and the program code are configured to, with the at least one processor, cause the apparatus to output the program configuration selection interface component for rendering to a program management interface of a computing device. In some embodiments, the at least one memory and the program code are configured to, with the at least one processor, cause the apparatus to identify configured program orchestration data via the program configuration selection interface component. In some embodiments, the at least one memory and the program code are configured to, with the at least one processor, cause the apparatus to generate one or more program external service node links based at least in part on the configured program orchestration data. In some embodiments, the at least one memory and the program code are configured to, with the at least one processor, cause the apparatus to configure an automated program subsidiary execution action engine based at least in part on the configured program orchestration data and one or more of the one or more program external service node links. In some embodiments, the at least one memory and the program code are configured to, with the at least one processor, cause the apparatus to initiate, using the automated program subsidiary execution action engine, performance of one or more program subsidiary execution actions.

In some embodiments, initiating performance of the one or more program subsidiary execution actions comprises the program code being further configured to, with the at least one processor, further cause the apparatus to initiate a first program subsidiary execution action. In some embodiments, initiating performance of the one or more program subsidiary execution actions comprises the program code being further configured to, with the at least one processor, further cause the apparatus to determine that the first program subsidiary execution action is complete. In some embodiments, initiating performance of the one or more program subsidiary execution actions comprises the program code being further configured to, with the at least one processor, further cause the apparatus to initiate a second program subsidiary execution action in response to the determination that the first program subsidiary execution action is complete.

In some embodiments, initiating performance of the one or more program subsidiary execution actions comprises the program code being further configured to, with the at least one processor, further cause the apparatus to identify a first program subsidiary execution action. In some embodiments, the first program subsidiary execution action is associated with an execution delay time period. In some embodiments, initiating performance of the one or more program subsidiary execution actions comprises the program code being further configured to, with the at least one processor, further cause the apparatus to determine that the execution delay time period has occurred. In some embodiments, initiating performance of the one or more program subsidiary execution actions comprises the program code being further configured to, with the at least one processor, further cause the apparatus to initiate the first program subsidiary execution action in response to the determination that the execution delay time period has occurred.

In some embodiments, initiating performance of the one or more program subsidiary execution actions comprises the program code being further configured to, with the at least one processor, further cause the apparatus to identify a first program subsidiary execution action. In some embodiments, the first program subsidiary execution action is associated with an execution delay program event. In some embodiments, initiating performance of the one or more program subsidiary execution actions comprises the program code being further configured to, with the at least one processor, further cause the apparatus to determine that the execution delay program event has occurred. In some embodiments, initiating performance of the one or more program subsidiary execution actions comprises the program code being further configured to, with the at least one processor, further cause the apparatus to initiate the first program subsidiary execution action in response to the determination that the execution delay program event has occurred.

In some embodiments, initiating performance of the one or more program subsidiary execution actions comprises the program code being further configured to, with the at least one processor, further cause the apparatus to initiate a first program subsidiary execution action. In some embodiments, initiating performance of the one or more program subsidiary execution actions comprises the program code being further configured to, with the at least one processor, further cause the apparatus to identify program subsidiary execution action input data. In some embodiments, initiating performance of the one or more program subsidiary execution actions comprises the program code being further configured to, with the at least one processor, further cause the apparatus to initiate a second program subsidiary execution action in response to the identification of the program subsidiary execution action input data.

In some embodiments, initiating performance of the one or more program subsidiary execution actions comprises the program code being further configured to, with the at least one processor, further cause the apparatus to initiate a first program subsidiary execution action. In some embodiments, the first program subsidiary execution action is associated with a program subsidiary execution occurrence time period. In some embodiments, initiating performance of the one or more program subsidiary execution actions comprises the program code being further configured to, with the at least one processor, further cause the apparatus to initiate a second program subsidiary execution action. In some embodiments, the second program subsidiary execution action is initiated during the program subsidiary execution occurrence time period.

In some embodiments, initiating performance of the one or more program subsidiary execution actions comprises the program code being further configured to, with the at least one processor, further cause the apparatus to initiate a first program subsidiary execution action. In some embodiments, initiating performance of the one or more program subsidiary execution actions comprises the program code being further configured to, with the at least one processor, further cause the apparatus to determine that the first program subsidiary execution action failed. In some embodiments, initiating performance of the one or more program subsidiary execution actions comprises the program code being further configured to, with the at least one processor, further cause the apparatus to reinitiate the first program subsidiary execution action in response to the determination that the first program subsidiary execution action failed.

In some embodiments, initiating performance of the one or more program subsidiary execution actions comprises the program code being further configured to, with the at least one processor, further cause the apparatus to initiate a first program subsidiary execution action. In some embodiments, initiating the first program subsidiary execution action includes identifying a first program subsidiary execution action and a second program subsidiary execution action. In some embodiments, initiating the first program subsidiary execution action includes generating a third program subsidiary execution action based at least in part on the first program subsidiary execution action and the second program subsidiary execution action.

In some embodiments, initiating performance of the one or more program subsidiary execution actions comprises the program code being further configured to, with the at least one processor, further cause the apparatus to initiate a first program subsidiary execution action. In some embodiments, initiating the first program subsidiary execution action includes generating a program subsidiary execution action executable configured to initiate performance of one or more other program subsidiary execution actions.

In some embodiments, the at least one memory and the program code are configured to, with the at least one processor, cause the apparatus to train the automated program subsidiary execution action engine based at least in part on aggregated configured program orchestration data.

In some embodiments, the one or more program external service node links comprise one or more of a program external technology service node link, a program external enterprise management service node link, a program external operations service node link, a program external communications service node link, a program external automation service node link, or a program external deployment service node link.

In some embodiments, the one or more program subsidiary execution actions comprise a program subsidiary incident execution action.

In some embodiments, the one or more program subsidiary execution actions comprise a program subsidiary integration execution action.

In some embodiments, the at least one memory and the program code are configured to, with the at least one processor, cause the apparatus to generate a configured program orchestration visualization interface component based at least in part on the configured program orchestration data. In some embodiments, the at least one memory and the program code are configured to, with the at least one processor, cause the apparatus to output the configured program orchestration visualization interface component for rendering to the program management interface of the computing device.

In some embodiments, the at least one memory and the program code are configured to, with the at least one processor, cause the apparatus to generate a program subsidiary execution action status interface component based at least in part on the one or more program subsidiary execution actions. In some embodiments, the at least one memory and the program code are configured to, with the at least one processor, cause the apparatus to output the program subsidiary execution action status interface component for rendering to the program management interface of the computing device.

In accordance with another exemplary embodiment of the present disclosure, an example method for initiating performance of one or more program subsidiary execution actions is provided. In some embodiments, the method includes generating a program configuration selection interface component based at least in part on unconfigured program orchestration data. In some embodiments, the method includes outputting the program configuration selection interface component for rendering to a program management interface of a computing device. In some embodiments, the method includes identifying configured program orchestration data via the program configuration selection interface component. In some embodiments, the method includes generating one or more program external service node links based at least in part on the configured program orchestration data. In some embodiments, the method includes configuring an automated program subsidiary execution action engine based at least in part on the configured program orchestration data and one or more of the one or more program external service node links. In some embodiments, the method includes initiating, using the automated program subsidiary execution action engine, performance of one or more program subsidiary execution actions.

In some embodiments, initiating performance of the one or more program subsidiary execution actions comprises initiating a first program subsidiary execution action. In some embodiments, initiating performance of the one or more program subsidiary execution actions comprises determining that the first program subsidiary execution action is complete. In some embodiments, initiating performance of the one or more program subsidiary execution actions comprises initiating a second program subsidiary execution action in response to the determination that the first program subsidiary execution action is complete.

In some embodiments, initiating performance of the one or more program subsidiary execution actions comprises identifying a first program subsidiary execution action. In some embodiments, the first program subsidiary execution action is associated with an execution delay time period. In some embodiments, initiating performance of the one or more program subsidiary execution actions comprises determining that the execution delay time period has occurred. In some embodiments, initiating performance of the one or more program subsidiary execution actions comprises initiating the first program subsidiary execution action in response to the determination that the execution delay time period has occurred.

In some embodiments, initiating performance of the one or more program subsidiary execution actions comprises identifying a first program subsidiary execution action. In some embodiments, the first program subsidiary execution action is associated with an execution delay program event. In some embodiments, initiating performance of the one or more program subsidiary execution actions comprises determining that the execution delay program event has occurred. In some embodiments, initiating performance of the one or more program subsidiary execution actions comprises initiating the first program subsidiary execution action in response to the determination that the execution delay program event has occurred.

In accordance with another exemplary embodiment of the present disclosure, a computer program product for initiating performance of one or more program subsidiary execution actions is provided. In some embodiments, the computer program product includes at least one non-transitory computer-readable storage medium having computer-readable program code portions stored therein, the computer-readable program code portions comprising an executable portion. In some embodiments, the computer-readable program code portions comprising an executable portion are configured to generate a program configuration selection interface component based at least in part on unconfigured program orchestration data. In some embodiments, the computer-readable program code portions comprising an executable portion are configured to output the program configuration selection interface component for rendering to a program management interface of a computing device. In some embodiments, the computer-readable program code portions comprising an executable portion are configured to identify configured program orchestration data via the program configuration selection interface component. In some embodiments, the computer-readable program code portions comprising an executable portion are configured to generate one or more program external service node links based at least in part on the configured program orchestration data. In some embodiments, the computer-readable program code portions comprising an executable portion are configured to configure an automated program subsidiary execution action engine based at least in part on the configured program orchestration data and one or more of the one or more program external service node links. In some embodiments, the computer-readable program code portions comprising an executable portion are configured to initiate, using the automated program subsidiary execution action engine, performance of one or more program subsidiary execution actions.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example program action orchestration operation system configured to communicate with various client devices in accordance with various example embodiments of the present disclosure;

FIG. 2 depicts a schematic block diagram of example circuitry to perform various operations in accordance with various example embodiments of the present disclosure;

FIG. 3 illustrates an example program configuration selection interface component in accordance with various example embodiments of the present disclosure;

FIGS. 4A and 4B illustrates an example configured program orchestration visualization interface component in accordance with various example embodiments of the present disclosure;

FIGS. 5A and 5B illustrates a program subsidiary execution action status interface component in accordance with various example embodiments of the present disclosure;

FIG. 6 depicts a flowchart diagram illustrating example operations for initiating performance of one or more program subsidiary execution actions in accordance with an example embodiment of the present disclosure;

FIG. 7 depicts a flowchart diagram illustrating example operations for outputting a configured program orchestration visualization interface component in accordance with an example embodiment of the present disclosure; and

FIG. 8 depicts a flowchart diagram illustrating example operations for outputting a program subsidiary execution action status interface component in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to enable efficient, reliable, dynamic, and secure initiation of program subsidiary execution actions and/or generation and provisioning of various interface components, such as a program configuration selection interface component, based on configured program orchestration data and/or using an automated program subsidiary execution action engine. This reduces computational load, provides a low latency user experience, and ensures secure access control of sensitive information.

Software development systems (e.g., Jira Software® or Jira Service Management® by Atlassian) enable enterprises to plan track, organize, schedule, address, repair, diagnose, execute, modify, transmit, and/or otherwise manage enterprise operations (e.g., enterprise incident response and enterprise user onboarding). In an agile program action orchestration operation environment, it is desirable for software development systems to implement various automated actions (e.g., actions to implement enterprise incident response operations and user onboarding operations). For example, in an agile program action orchestration operation environment, it is desirable to automate complex and interrelated automated actions in order to enable efficient, dynamic, and reliable enterprise operations. However, many software development systems are associated with non-agile environments and, as a result, are simplistic and lack automation capabilities. Thus, many software development systems have limited ability to implement automated actions in an agile program action orchestration operation environment to enable complex and automated enterprise operations. As a result, it is not possible for software development systems to efficiently, dynamically, and reliably enable enterprise operations in an agile program action orchestration operation environment.

In some examples, software development systems are not able to dynamically and efficiently implement various enterprise operations in a program action orchestration operation environment because such software development systems are not able to automate complex and interrelated program subsidiary execution actions (e.g., delayed program subsidiary execution actions, parallel program subsidiary execution actions, asynchronous program subsidiary execution actions, etc.). In some examples, software development systems are not able to efficiently and reliably implement various enterprise operations in a program action orchestration operation environment, because such software development systems are not able to provide tools to generate and automate program subsidiary execution actions (e.g., low code or no code tools to generate and automate program subsidiary execution actions). In some examples, software development systems are not able to dynamically and reliably implement various enterprise operations in a program action orchestration operation environment, because such software development systems in a program action orchestration operation environment are not able to integrate with external applications (e.g., third party applications) that assist in performing program subsidiary execution actions.

In order to address these technical challenges, the inventors have determined that it is desirable to implement a program action orchestration operation system to configure an automated program subsidiary execution action engine. The automated program subsidiary execution action engine may be configured based on configured program orchestration data and/or one or more of the one or more program external service node links and may be used to initiate performance of one or more program subsidiary execution actions (e.g., incident response actions and user onboarding actions). As a result, the automated program subsidiary execution action engine enables the dynamic and efficient implementation of enterprise operations in an program action orchestration operation environment by automating complex and interrelated program subsidiary execution actions (e.g., automating delayed program subsidiary execution actions, parallel program subsidiary execution actions, asynchronous program subsidiary execution actions, etc.).

In order to address these technical challenges, the inventors have determined that it is desirable to implement a program action orchestration operation system to generate a program configuration selection interface component. The program configuration selection interface component may be outputted to a program management interface and configured program orchestration data may be identified via the program configuration selection interface component. As a result, the program configuration selection interface component enables the efficient and reliable implementation of enterprise operations by providing tools to generate and/or automate program subsidiary execution actions (e.g., a low code or no code tool to generate and/or automate program subsidiary execution actions).

In order to address these technical challenges, the inventors have determined that it is desirable to implement a program action orchestration operation system to generate program external service node links. The program external service node links may be generated based on configured program orchestration data and may be used to integrate a program action orchestration operation system with external applications that assist in performing program subsidiary execution actions. As a result, the program external service node links enable the dynamic and reliable implementation of enterprise operations in a program action orchestration operation environment by integrating program action orchestration operation systems in an agile program action orchestration operation environment with supporting third party applications.

### Definitions

The following explanations of terms are provided to better describe the present disclosure and to guide those of ordinary skill in the art in the practice of the present disclosure.

As used herein, the term “program action orchestration operation system” refers to the software platform(s) and associated hardware configured to support and maintain a plurality of projects, workflows, and all associated functionality. For example, a program action orchestration operation system may comprise a software product such as Jira® by Atlassian®. Example program action orchestration operation systems comprise supporting server(s) and repositor(ies), and in some embodiments, are further configured to engage with internal resources, external resources, internal applications, and/or external applications.

As used herein, the term “program action orchestration operation server” refers to a software platform and associated hardware that is configured to, inter alia, manage the various interfaces and/or interface components and associated functionality of the program action orchestration operation system. For example, in some embodiments, the program action orchestration operation server is configured to generate, manage, output, and/or update program management interfaces, program configuration selection interface components, configured program orchestration visualization interface components, and/or program subsidiary action status interface components.

As another example, in some embodiments, the program action orchestration operation server is configured to identify, determine, generate, manage, interact with, and/or output unconfigured program orchestration data, configured program orchestration data, program subsidiary execution action input data, aggregated configured program orchestration data, program external service node links, program external service nodes, and/or program internal service nodes.

As another example, in some embodiments, the program action orchestration operation server is configured to generate, perform, cause, initiate, and/or implement program subsidiary execution actions, program subsidiary incident execution actions, program subsidiary integration execution actions, execution delay program events, execution delay time periods, program subsidiary execution occurrence time periods, and/or program subsidiary execution action executables.

As another example, in some embodiments, the program action orchestration operation server is configurated to generate, train, and/or refine automated program subsidiary execution action engines, trained machine learning models, rules-based models, and/or statistical models. The functionality of the program action orchestration operation server may be provided via a single server or collection of servers having a common functionality, or the functionality of the program action orchestration operation server may be segmented among a plurality of servers or collections of servers (e.g., a cloud networking environment, microservices, and/or the like) performing subsets of the described functionality of the program action orchestration operation server.

As used herein, the term “program action orchestration operation data repository” refers to a location, such as a database stored on a memory device, which is accessible by one or more computing devices for retrieval and storage of data associated with the program action orchestration operation system. For example, the program action orchestration operation data repository may include unconfigured program orchestration data, configured program orchestration data, program subsidiary execution action input data, aggregated configured program orchestration data, program external service node links, program subsidiary execution actions, program subsidiary incident execution actions, program subsidiary integration execution actions, execution delay program events, execution delay time periods, program subsidiary execution occurrence time periods, program subsidiary execution action executables, automated program subsidiary execution action engines, and/or the like.

As used herein, the terms “program action orchestration operation application” or “program action orchestration operation app” refer to a dedicated software program, application, platform, service, web browser, or computer-executable application software programmed or configured to run on a client device which provides a user access to the program action orchestration operation system and its associated functionality. In some embodiments, the program action orchestration operation application may include hardware, software, or combinations thereof operating remotely (e.g., on a server). In some embodiments, the program action orchestration operation application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

As used herein, the term “unconfigured program orchestration data” refers to one or more items of data indicative and/or representative of one or more program subsidiary execution actions, program internal service nodes, and/or program external service nodes. In some embodiments, unconfigured program orchestration data may be stored in a program action orchestration operation data repository.

As used herein, the term “program subsidiary execution action” refers to an actionable item, work item, issue, and/or task that may be performed by a program action orchestration operation server and/or a user associated with a program action orchestration operation server. In some embodiments, a program subsidiary execution action may include a program subsidiary incident execution action and/or a program subsidiary integration execution action.

As used herein, the term “program subsidiary incident execution action” refers to an incident actionable item, incident work item, incident issue, and/or incident task that may be performed by a program action orchestration operation server and/or a user associated with a program action orchestration operation server. For example, a program subsidiary incident execution action may include performing a portal request. As another example, a program subsidiary incident execution action may include performing data monitoring.

As another example, a program subsidiary incident execution action may include analyzing a historical log. As another example, a program subsidiary incident execution action may include validating an incident alert. As another example, a program subsidiary incident execution action may include generating incident alert documentation. As another example, a program subsidiary incident execution action may include identifying services affected by an incident. As another example, a program subsidiary incident execution action may include generating and/or assigning a ticket. As another example, a program subsidiary incident execution action may include transmitting an incident notification.

As another example, a program subsidiary incident execution action may include performing incident diagnostics. As another example, a program subsidiary incident execution action may include generating an incident resolution. As another example, a program subsidiary incident execution action may include performing incident resolution validation. As another example, a program subsidiary incident execution action may include notifying affected services of incident resolution. As another example, a program subsidiary incident execution action may include generating incident cause documentation. As another example, a program subsidiary incident execution action may include generating incident resolution documentation.

As used herein, the term “program subsidiary integration execution action” refers to an integration actionable item, integration work item, integration issue, and/or integration task that may be performed by a program action orchestration operation server and/or a user associated with a program action orchestration operation server. For example, a program subsidiary integration execution action may include generating user integration documentation. As another example, a program subsidiary integration execution action may include generating a user integration ticket.

As another example, a program subsidiary integration execution action may include generating a user account. As another example, a program subsidiary integration execution action may include selecting user software. As another example, a program subsidiary integration execution action may include generating facilities access documentation. As another example, a program subsidiary integration execution action may include generating facilities workstation setup documentation. As another example, a program subsidiary integration execution action may include generating user workstation items documentation. As another example, a program subsidiary integration execution action may include associating a user with procurement. As another example, a program subsidiary integration execution action may include associating a user with relevant team members.

As used herein, the term “program internal service node” refers to one or more data processing services internal to the program action orchestration operation system configured to assist in performing one or more program subsidiary execution actions. For example, a program internal service node may be one or more data processing services internal to the program action orchestration operation system configured to assist in performing one or more program subsidiary integration execution actions and/or program subsidiary incident execution actions.

As used herein, the term “program external service node” refers to one or more data processing services external to the program action orchestration operation system configured to assist in performing one or more program subsidiary execution actions. For example, a program external service node may be one or more data processing services external to the program action orchestration operation system configured to assist in performing one or more program subsidiary integration execution actions and/or program subsidiary incident execution actions. In some embodiments, a program external service node may include one or more program external technology service nodes, program external enterprise management service nodes, program external operations service nodes, program external communications service nodes, program external automation service nodes, and/or program external deployment service nodes.

As used herein, the term “program external technology service node” refers to one or more technology data processing services external to the program action orchestration operation system configured to assist in performing one or more program subsidiary execution actions. In some embodiments, a program external technology service node may be one or more technology data processing services external to the program action orchestration operation system configured to assist in performing one or more program subsidiary integration execution actions. For example, a program external technology service node may be one or more technology data processing services external to the program action orchestration operation system configured to assist in performing a program subsidiary integration execution action that includes selecting user software. As another example, a program external technology service node may be one or more technology data processing services external to the program action orchestration operation system configured to assist in performing a program subsidiary integration execution action that includes generating user workstation items documentation.

In some embodiments, a program external technology service node may be one or more technology data processing services external to the program action orchestration operation system configured to assist in performing one or more program subsidiary incident execution actions. For example, a program external technology service node may be one or more technology data processing services external to the program action orchestration operation system configured to assist in performing a program subsidiary incident execution action that includes performing data monitoring. As another example, a program external technology service node may be one or more technology data processing services external to the program action orchestration operation system configured to assist in performing a program subsidiary incident execution action that includes analyzing a historical log. As another example, a program external technology service node may be one or more technology data processing services external to the program action orchestration operation system configured to assist in performing a program subsidiary incident execution action that includes performing incident diagnostics.

As used herein, the term “program external enterprise management service node” refers to one or more enterprise management data processing services external to the program action orchestration operation system configured to assist in performing one or more program subsidiary execution actions. In some embodiments, a program external enterprise management service node may be one or more enterprise management data processing services external to the program action orchestration operation system configured to assist in performing one or more program subsidiary integration execution actions. For example, a program external enterprise management service node may be one or more enterprise management data processing services external to the program action orchestration operation system configured to assist in performing a program subsidiary integration execution action that includes generating a user account.

In some embodiments, a program external enterprise management service node may be one or more enterprise management data processing services external to the program action orchestration operation system configured to assist in performing one or more program subsidiary incident execution actions. For example, a program external enterprise management service node may be one or more enterprise management data processing services external to the program action orchestration operation system configured to assist in performing a program subsidiary incident execution action that includes identifying services affected by an incident. As another example, a program external enterprise management service node may be one or more enterprise management data processing services external to the program action orchestration operation system configured to assist in performing a program subsidiary incident execution action that includes generating and/or assigning a ticket.

As used herein, the term “program external operations service node” refers to one or more operations data processing services external to the program action orchestration operation system configured to assist in performing one or more program subsidiary execution actions. In some embodiments, a program external operations service node may be one or more operations data processing services external to the program action orchestration operation system configured to assist in performing one or more program subsidiary integration execution actions. For example, a program external operations service node may be one or more operations data processing services external to the program action orchestration operation system configured to assist in performing a program subsidiary integration execution action that includes generating a user integration ticket. As another example, a program external operations service node may be one or more operations data processing services external to the program action orchestration operation system configured to assist in performing a program subsidiary integration execution action that includes generating facilities workstation setup documentation.

In some embodiments, a program external operations service node may be one or more operations data processing services external to the program action orchestration operation system configured to assist in performing one or more program subsidiary incident execution actions. For example, a program external operations service node may be one or more operations data processing services external to the program action orchestration operation system configured to assist in performing a program subsidiary incident execution action that includes performing a portal request. As another example, a program external operations service node may be one or more operations data processing services external to the program action orchestration operation system configured to assist in performing a program subsidiary incident execution action that includes generating incident cause documentation. As another example, a program external operations service node may be one or more operations data processing services external to the program action orchestration operation system configured to assist in performing a program subsidiary incident execution action that includes generating incident resolution documentation.

As used herein, the term “program external communications service node” refers to one or more communications data processing services external to the program action orchestration operation system configured to assist in performing one or more program subsidiary execution actions. In some embodiments, a program external communications service node may be one or more communications data processing services external to the program action orchestration operation system configured to assist in performing one or more program subsidiary integration execution actions. For example, a program external communications service node may be one or more communications data processing services external to the program action orchestration operation system configured to assist in performing a program subsidiary integration execution action that includes associating a user with relevant team members.

In some embodiments, a program external communications service node may be one or more communications data processing services external to the program action orchestration operation system configured to assist in performing one or more program subsidiary incident execution actions. For example, a program external communications service node may be one or more communications data processing services external to the program action orchestration operation system configured to assist in performing a program subsidiary incident execution action that includes notifying affected services of incident resolution. As another example, a program external communications service node may be one or more communications data processing services external to the program action orchestration operation system configured to assist in performing a program subsidiary incident execution action that includes transmitting an incident notification.

As used herein, the term “program external automation service node” refers to one or more automation data processing services external to the program action orchestration operation system configured to assist in performing one or more program subsidiary execution actions. In some embodiments, a program external automation service node may be one or more automation data processing services external to the program action orchestration operation system configured to assist in performing one or more program subsidiary integration execution actions. For example, a program external automation service node may be one or more automation data processing services external to the program action orchestration operation system configured to assist in performing a program subsidiary integration execution action that includes generating user integration documentation. As another example, a program external automation service node may be one or more automation data processing services external to the program action orchestration operation system configured to assist in performing a program subsidiary integration execution action that includes generating a user integration ticket.

In some embodiments, a program external automation service node may be one or more automation data processing services external to the program action orchestration operation system configured to assist in performing one or more program subsidiary incident execution actions. For example, a program external automation service node may be one or more automation data processing services external to the program action orchestration operation system configured to assist in performing a program subsidiary incident execution action that includes validating an incident alert. As another example, a program external automation service node may be one or more automation data processing services external to the program action orchestration operation system configured to assist in performing a program subsidiary incident execution action that includes generating incident cause documentation. As another example, a program external automation service node may be one or more automation data processing services external to the program action orchestration operation system configured to assist in performing a program subsidiary incident execution action that includes generating incident resolution documentation.

As used herein, the term “program external deployment service node” refers to one or more deployment data processing services external to the program action orchestration operation system configured to assist in performing one or more program subsidiary execution actions. In some embodiments, a program external deployment service node may be one or more deployment data processing services external to the program action orchestration operation system configured to assist in performing one or more program subsidiary integration execution actions. For example, a program external deployment service node may be one or more deployment data processing services external to the program action orchestration operation system configured to assist in performing a program subsidiary integration execution action that includes associating a user with procurement.

In some embodiments, a program external deployment service node may be one or more deployment data processing services external to the program action orchestration operation system configured to assist in performing one or more program subsidiary incident execution actions. For example, a program external deployment service node may be one or more deployment data processing services external to the program action orchestration operation system configured to assist in performing a program subsidiary incident execution action that includes generating an incident resolution.

As used herein, the term “program external service node link” refers to a data object that enables communication between a program action orchestration operation system and a program external service node. In some embodiments, a program external service node link may be a data object enables communication between a program action orchestration operation system and a program external service node such that a program external service node may assist in performing one or more program subsidiary execution actions. For example, a program external service node link may be a data object that enables communication between a program action orchestration operation system and a program external service node such that a program external service node may assist in performing one or more program subsidiary incident execution actions and/or program subsidiary integration execution actions. In some embodiments, a program external service node link may be one or more of a program external technology service node link, program external enterprise management service node link, program external operations service node link, program external communications service node link, program external automation service node link, and/or a program external deployment service node link.

As used herein, the term “program external technology service node link” refers to a data object that enables communication between a program action orchestration operation system and a program external technology service node. In some embodiments, a program external technology service node link may be a data object enables communication between a program action orchestration operation system and a program external technology service node such that a program external technology service node may assist in performing one or more program subsidiary execution actions. For example, a program external technology service node link may be a data object that enables communication between a program action orchestration operation system and a program external technology service node such that a program external technology service node may assist in performing one or more program subsidiary incident execution actions and/or program subsidiary integration execution actions.

As used herein, the term “program external enterprise management service node link” refers to a data object that enables communication between a program action orchestration operation system and a program external enterprise management service node. In some embodiments, a program external enterprise management service node link may be a data object enables communication between a program action orchestration operation system and a program external enterprise management service node such that a program external enterprise management service node may assist in performing one or more program subsidiary execution actions. For example, a program external enterprise management service node link may be a data object that enables communication between a program action orchestration operation system and a program external enterprise management service node such that a program external enterprise management service node may assist in performing one or more program subsidiary incident execution actions and/or program subsidiary integration execution actions.

As used herein, the term “program external operations service node link” refers to a data object that enables communication between a program action orchestration operation system and a program external operations service node. In some embodiments, a program external operations service node link may be a data object enables communication between a program action orchestration operation system and a program external operations service node such that a program external operations service node may assist in performing one or more program subsidiary execution actions. For example, a program external operations service node link may be a data object that enables communication between a program action orchestration operation system and a program external operations service node such that a program external operations service node may assist in performing one or more program subsidiary incident execution actions and/or program subsidiary integration execution actions.

As used herein, the term “program external communications service node link” refers to a data object that enables communication between a program action orchestration operation system and a program external communications service node. In some embodiments, a program external communications service node link may be a data object enables communication between a program action orchestration operation system and a program external communications service node such that a program external communications service node may assist in performing one or more program subsidiary execution actions. For example, a program external communications service node link may be a data object that enables communication between a program action orchestration operation system and a program external communications service node such that a program external communications service node may assist in performing one or more program subsidiary incident execution actions and/or program subsidiary integration execution actions.

As used herein, the term “program external automation service node link” refers to a data object that enables communication between a program action orchestration operation system and a program external automation service node. In some embodiments, a program external automation service node link may be a data object enables communication between a program action orchestration operation system and a program external automation service node such that a program external automation service node may assist in performing one or more program subsidiary execution actions. For example, a program external automation service node link may be a data object that enables communication between a program action orchestration operation system and a program external automation service node such that a program external automation service node may assist in performing one or more program subsidiary incident execution actions and/or program subsidiary integration execution actions.

As used herein, the term “program external deployment service node link” refers to a data object that enables communication between a program action orchestration operation system and a program external deployment service node. In some embodiments, a program external deployment service node link may be a data object enables communication between a program action orchestration operation system and a program external deployment service node such that a program external deployment service node may assist in performing one or more program subsidiary execution actions. For example, a program external deployment service node link may be a data object that enables communication between a program action orchestration operation system and a program external deployment service node such that a program external deployment service node may assist in performing one or more program subsidiary incident execution actions and/or program subsidiary integration execution actions.

As used herein, the term “program management interface” refers to a graphical user interface of a program action orchestration operation server that is configured to enable one or more users to view and engage with one or more program action orchestration operation system workspaces, views, and/or interface components. In some embodiments, for example, a program management interface is configured to enable one or more users to view and engage with one or more program configuration selection interface components, program configuration selection item interface components, program configuration selection action interface components, configured program orchestration visualization interface components, and/or program subsidiary execution action status interface components. In some embodiments, a program management interface may be rendered to a client device based on data provided by program action orchestration operation (e.g., using a program action orchestration operation server). In some embodiments, such data and instructions are facilitated by a dedicated software application running on the client device. In other embodiments, such data and instructions are provided through a web browser running on the client device.

As used herein, the term “program configuration selection interface component” refers to a graphical user interface element that is rendered to or as a portion of, a program management interface of a program action orchestration operation system. In some embodiments, a program configuration selection interface component may be configured to display a program configuration selection item interface component and/or a program configuration selection action interface component. In some embodiments, a program configuration selection interface component may be configured to display a program configuration selection item interface component proximate a program configuration selection action interface component.

As used herein, the term “program configuration selection item interface component” refers to a graphical user interface element that is rendered to or as a portion of, a program configuration selection interface component of a program action orchestration operation system. In some embodiments, a program configuration selection item interface component may be configured to display one or more program subsidiary execution actions, such as one or more program subsidiary incident execution actions and/or program subsidiary integration execution actions. Additionally, or alternatively, in some embodiments, a program configuration selection item interface component may be configured to display one or more program external service nodes and/or program internal service nodes. In some embodiments, a program configuration selection item interface component may be configured with drag and drop functionality. In this regard, for example, a program configuration selection item interface component may be configured such that a user associated with a program configuration selection item interface component may drag one or more program subsidiary execution actions, program external service nodes, and/or program internal service nodes from a program configuration selection item interface component to another interface component (e.g., a program configuration selection action interface component). In this regard, for example, a program configuration selection item interface component may be configured to at least partially generate and/or identify configured program orchestration data based at least in part on unconfigured program orchestration data.

As used herein, the term “program configuration selection action interface component” refers to a graphical user interface element that is rendered to or as a portion of, a program configuration selection interface component of a program action orchestration operation system. In some embodiments, a program configuration selection action interface component may be configured to display one or more program subsidiary execution actions, such as one or more program subsidiary incident execution actions and/or program subsidiary integration execution actions. Additionally, or alternatively, in some embodiments, a program configuration selection action interface component may be configured to display one or more program external service nodes and/or program internal service nodes. In some embodiments, a program configuration selection action interface component may be configured with drag and drop functionality. In this regard, for example, a program configuration selection action interface component may be configured such that a user associated with a program configuration selection action interface component may drag one or more program subsidiary execution actions, program external service nodes, and/or program internal service nodes from another interface component (e.g., a program configuration selection item interface component) to a program configuration selection action interface component. In this regard, for example, a program configuration selection action interface component may be configured to at least partially generate and/or identify configured program orchestration data based at least in part on unconfigured program orchestration data.

As used herein, the term “enterprise” refers to a data object representative of and/or associated with a particular entity (e.g., a software development company) and/or users associated with a particular entity (e.g., employees or contractors associated with a software development company).

As used herein, the term “configured program orchestration data” refers to one or more items of data indicative and/or representative of one or more program subsidiary execution actions, program internal service nodes, and/or program external service nodes configured in an ordered combination. In some embodiments, configured program orchestration data may be one or more items of data indicative and/or representative of one or more program subsidiary execution actions, program internal service nodes, and/or program external service nodes configured in an ordered combination that is associated with an objective, project, and/or the like of an enterprise. In some embodiments, configured program orchestration data may be stored in a program action orchestration operation data repository.

As used herein, the term “configured program orchestration visualization interface component” refers to a graphical user interface element that is rendered to or as a portion of, a program management interface of a program action orchestration operation system. In some embodiments, a configured program orchestration visualization interface component may be configured to display configured program orchestration data. In some embodiments, a configured program orchestration visualization interface component may be based at least in part on configured program orchestration data.

As used herein, the term “automated program subsidiary execution action engine” refers to a software application configured to at least in part initiate performance of one or more program subsidiary execution actions. For example, an automated program subsidiary execution action engine may be a software application configured to at least in part initiate performance of one or more program subsidiary incident execution actions and/or program subsidiary integration execution actions. In some embodiments, an automated program subsidiary execution action engine may be configured based at least in part on configured program orchestration data and/or program external service node links. In this regard, an automated program subsidiary execution action engine may be a software application configured to at least in part initiate performance of one or more program subsidiary execution actions based at least in part on configured program orchestration data and/or program external service node links.

In some embodiments, an automated program subsidiary execution action engine may be configured to be trained. In some embodiments, an automated program subsidiary execution action engine may be configured to be trained based at least in part on aggregated configured program orchestration data. In some embodiments, an automated program subsidiary execution action engine may include a machine learning model. In this regard, for example, a machine learning model of an automated program subsidiary execution action engine may be configured to be trained using aggregated configured program orchestration data. In some embodiments, an automated program subsidiary execution action engine may be executed and/or used by a program action orchestration operation system (e.g., a program action orchestration operation server) to initiate performance of one or more program subsidiary execution actions.

As used herein, the term “aggregated configured program orchestration data” refers to one or more items of data indicative and/or representative of an aggregation of historical program subsidiary execution actions, historical program internal service nodes, and/or historical program external service nodes configured in an ordered combination. In some embodiments, aggregated configured program orchestration data may be one or more items of data indicative and/or representative of an aggregation of historical program subsidiary execution actions, historical program internal service nodes, and/or historical program external service nodes configured in an ordered combination that is associated with an historical objective, historical project, and/or the like of an enterprise. In some embodiments, aggregated configured program orchestration data may be used to train an automated program subsidiary execution action engine. In some embodiments, aggregated configured program orchestration data may be stored in a program action orchestration operation data repository.

As used herein, the term “execution delay time period” refers to a timeboxed period, time interval, and/or unit of time that occurs before a program subsidiary execution action is initiated. For example, a program action orchestration operation system may be configured to initiate a program subsidiary execution action based at least in part on a determination that an execution delay time period has occurred.

As used herein, the term “execution delay program event” refers to an event that occurs before a program subsidiary execution action is initiated. For example, a program action orchestration operation system may be configured to initiate a program subsidiary execution action based at least in part on a determination that an execution delay program event has occurred.

As used herein, the term “program subsidiary execution action input data” refers to one or more items of data representative of and/or associated with information associated with initiating performance of a program subsidiary execution action. For example, a program action orchestration operation system may be configured to initiate a program subsidiary execution action based at least in part on identifying program subsidiary execution action input data. In some embodiments, program subsidiary execution action input data may be provided to a program action orchestration operation system by a user, such as via an interface. In some embodiments, program subsidiary execution action input data may be stored in a program action orchestration operation data repository.

As used herein, the term “program subsidiary execution occurrence time period” refers to a timeboxed period, time interval, and/or unit of time in which at least two program subsidiary execution actions are initiated. For example, a program action orchestration operation system may be configured to initiate a first program subsidiary execution action and a second program subsidiary execution action during a program subsidiary execution occurrence time period. In some embodiments, the second program subsidiary execution action may be initiated at the same time as the first program subsidiary execution action and/or before the first program subsidiary execution action is completed.

As used herein, the term “program subsidiary execution action executable” refers to computer program code that is executed and/or executable by a program action orchestration operation system to initiate performance of one or more program subsidiary execution actions. In some embodiments, a program action orchestration operation system may be configured to generating a program subsidiary execution action executable by initiating performance of a program subsidiary execution action.

As used herein, the term “program subsidiary execution action status interface component” refers to a graphical user interface element that is rendered to or as a portion of, a program management interface of a program action orchestration operation system. In some embodiments, a program subsidiary execution action status interface component may be configured to display the status of one or more program subsidiary execution actions. For example, a program subsidiary execution action status interface component may be configured to display completed program subsidiary execution actions, in progress program subsidiary execution actions, and/or program subsidiary execution actions that have yet to be initiated. In some embodiments, a program subsidiary execution action status interface component may be generated based at least in part on one or more program subsidiary execution actions.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., an operation and escalation management server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity—relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary”, or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Example Systems and Apparatuses of the Disclosure

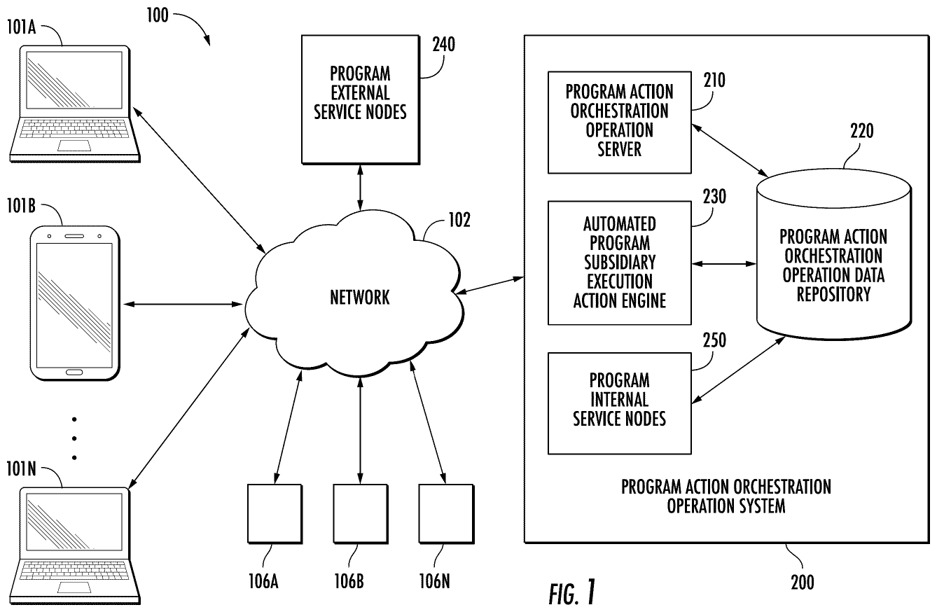

Referring now to FIG. 1, an example computing system 100 architecture within which some embodiments of the present disclosure operate is illustrated. The example computing system 100 comprises one or more software development tools 106A-106N, program action orchestration operation system 200, and a plurality of client devices 101A-101N, each communicatively connected through a communications network 102. Accordingly, user(s) (e.g., team member, individual contributor, team leader, team member, designer, etc.) may access the program action orchestration operation system 200 via the communications network 102 using one or more of client devices 101A-101N. In some embodiments, the example computing system 100 includes one or more program external service nodes 240. In some embodiments, the program action orchestration operation system 200 includes one or more program internal service nodes 250. Program action orchestration operation system 200 may comprise a program action orchestration operation server 210 in communication with at least one repository, such as a program action orchestration operation data repository 220. Such repository(ies) may be hosted by the program action orchestration operation server 210 or otherwise hosted by devices in communication with the program action orchestration operation server 210.

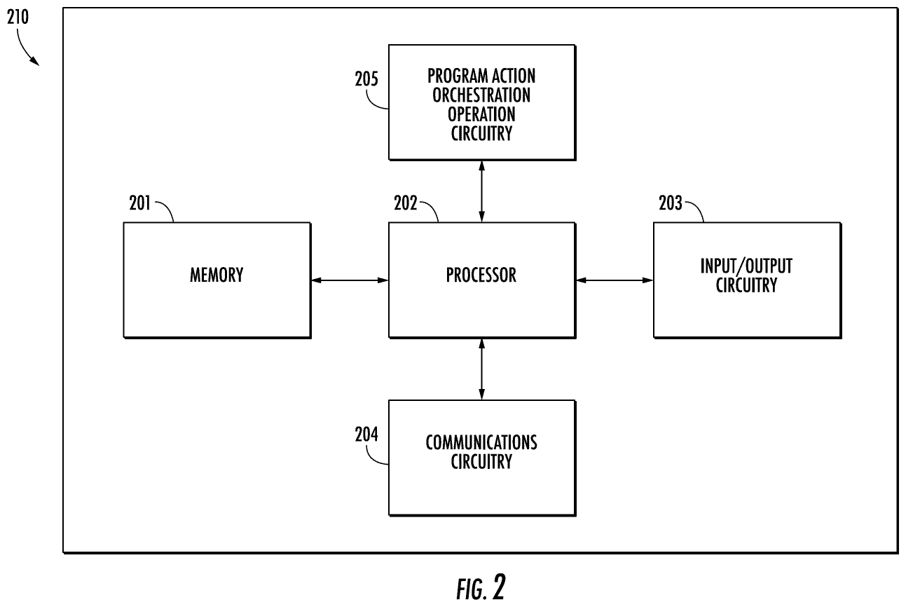

Program action orchestration operation server 210 may include circuitry, networked processors, or the like configured to perform some or all of the program action orchestration operation server-based processes described herein and may be any suitable network server and/or other type of processing device. In some embodiments, program action orchestration operation server 210 may determine and transmit commands and instructions for rendering one or more program management interfaces to client devices 101A-101N, using data from, for example, the program action orchestration operation data repository 220. In this regard, the program action orchestration operation server 210 may be embodied by any of a variety of devices, for example, the program action orchestration operation server 210 may be embodied as a computer or a plurality of computers. For example, program action orchestration operation server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, program action orchestration operation server 210 may be located remotely from the program action orchestration operation data repository 220, although in other embodiments, the program action orchestration operation server 210 may comprise the program action orchestration operation data repository 220. The program action orchestration operation server 210 may, in some embodiments, comprise several servers or computing devices performing interconnected and/or distributed functions. Despite the many arrangements contemplated herein, program action orchestration operation server 210 is shown and described herein as a single computing device to avoid unnecessarily overcomplicating the disclosure.

Program action orchestration operation server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the program action orchestration operation system 200.

The program action orchestration operation data repository 220 may be stored by any suitable storage device configured to store some or all of the information described herein (e.g., memory 201 of the program action orchestration operation server 210 or a separate memory system separate from the program action orchestration operation server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The program action orchestration operation data repository 220 may comprise data received from the program action orchestration operation server 210 (e.g., via a memory 201 and/or processor(s) 202), and the corresponding storage device may thus store this data. The program action orchestration operation data repository 220 includes information accessed and stored by the program action orchestration operation server 210 to facilitate the operations of the program action orchestration operation system 200. As such, the program action orchestration operation data repository 220 may include, for example, without limitation, include unconfigured program orchestration data, program orchestration data, automated program subsidiary execution action engines, program subsidiary execution action input data, program subsidiary orchestration items, program subsidiary execution action executables, aggregated configured program orchestration data, aggregated program subsidiary execution actions, and/or the like.

Software development tools 106A-106N may be any one or more underlying software development tools (e.g., Bitbucket®, etc.).

The client devices 101A-101N may be implemented as any computing device as defined above. Electronic data received by the program action orchestration operation server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the program management interface to a user and otherwise providing access to the program action orchestration operation system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least the program management interface, which may be provided by the program action orchestration operation system 200. According to further embodiments, the client devices 101A-101N may be configured to generate and/or display a program configuration selection interface component, a program configuration selection item interface component, a program configuration selection action interface component, a configured program orchestration visualization interface component, a program subsidiary execution action status interface component, and/or the like.

In embodiments where a client device 101A-101N is a mobile device, such as a smartphone or tablet, the client device 101A-101N may execute an “app” to interact with the program action orchestration operation system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the program action orchestration operation system 200 via a web browser. As yet another example, the client devices 101A-101N may include various hardware or firmware designed to interface with the program action orchestration operation system 200.

### Example Apparatus for Implementing Embodiments of the Present Disclosure

FIG. 2 illustrates an example program action orchestration operation server 210 in accordance with at least some example embodiments of the present disclosure. In accordance with some example embodiments, program action orchestration operation server 210 may include various components, modules, circuitries, or means, some or all of which may be also or instead be included in one or more client device(s) 101A-101N. In accordance with some example embodiments, program action orchestration operation server 210 may be configured, using one or more of the sets of circuitry embodying memory 201, processor 202, input/output circuitry 203, communications circuitry 204, and/or program action orchestration operation circuitry 205 to execute and perform the operations described herein. In some embodiments, program action orchestration operation circuitry 205 is included in program action orchestration operation server 210 and/or client device 101A, the circuitry configured to facilitate the functionality discussed herein regarding generating a program configuration selection interface component, a program configuration selection item interface component, a program configuration selection action interface component, a configured program orchestration visualization interface component, a program subsidiary execution action status interface component, and/or the like. In some embodiments, program action orchestration operation circuitry 205 is configured to initiate performance of one or more program subsidiary execution actions. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with program action orchestration operation server 210, other elements of the program action orchestration operation server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, program action orchestration operation server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., program action orchestration operation server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling program action orchestration operation server 210 to carry out various functions in accordance with example embodiments discussed herein. For example, in at least some embodiments, memory 201 is configured to buffer data for processing by processor 202. Additionally, or alternatively, in at least some embodiments, memory 201 is configured to store program instructions for execution by processor 202. Memory 201 may store information in the form of static and/or dynamic information. This stored information may be stored and/or used by program action orchestration operation server 210 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as program action orchestration operation server 210. The plurality of processors may be in operative communication with each other and may be collectively configured to perform one or more functionalities of program action orchestration operation server 210 as described herein.

In an example embodiment, processor 202 is configured to execute instructions stored in the memory 201 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause program action orchestration operation server 210 to perform one or more of the functionalities of program action orchestration operation server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., program management interface) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in program action orchestration operation server 210 may be reduced when implemented also or instead as an end-user machine or other type of device designed for complex user interactions (i.e., client device 101). In some embodiments (like other components discussed herein), input/output circuitry 203 may even be eliminated from program action orchestration operation server 210. Alternatively, at least some aspects of input/output circuitry 203 may be embodied on an apparatus used by a user (e.g., a team member, an individual contributor, a team leader, and/or the like) that is in communication with program action orchestration operation server 210. Input/output circuitry 203 may be in communication with memory 201, communications circuitry 204, and/or any other component(s), such as via a bus. Although more than one input/output circuitry and/or other component can be included in program action orchestration operation server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with program action orchestration operation server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by program action orchestration operation server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of program action orchestration operation server 210, such as via a bus.

In some embodiments, program action orchestration operation circuitry 205 may also or instead be included and configured to perform the functionality discussed herein related to providing a program management interface, a program configuration selection interface component, a program configuration selection item interface component, a program configuration selection action interface component, a configured program orchestration visualization interface component, a program subsidiary execution action status interface component, and/or the like. Program action orchestration operation circuitry 205 includes hardware components and/or software configured to support interface component functionality, features, and/or services of the program action orchestration operation server 210. In some embodiments, program action orchestration operation circuitry 205 includes hardware components and/or software configured to support an automated program subsidiary execution action engine 230 to generate, determine, and/or initiate performance of program subsidiary execution actions, features, and/or services of the program action orchestration operation server 210. The program action orchestration operation circuitry 205 may utilize processing circuitry, such as the processor 202, to perform its corresponding operations, and may utilize memory 201 to store collected information. The program action orchestration operation circuitry 205 may send and/or receive data from the program action orchestration operation data repository 220. In some implementations, the sent and/or received data may include unconfigured program orchestration data, configured program orchestration data, aggregated configured program orchestration data, program subsidiary execution action input data, program external service node links, and/or associated data that is associated with, for example, initiating performance of one or more program subsidiary execution actions and/or generating a program configuration selection interface component, a program configuration selection item interface component, a program configuration selection action interface component, a configured program orchestration visualization interface component, a program subsidiary execution action status interface component, and/or the like.

It should also be appreciated that, in some embodiments, the program action orchestration operation circuitry 205 may include a separate processor, specially configured field programmable gate array (FPGA), or application specific interface circuit (ASIC) to perform its corresponding functions. For example, in some embodiments, some or all of the functionality of program action orchestration operation circuitry 205 may be performed by processor 202. In this regard, some or all of the example processes and algorithms discussed herein can be performed by at least one processor 202 and/or program action orchestration operation circuitry 205. For example, non-transitory computer readable storage media can be configured to store firmware, one or more application programs, and/or other software, which include instructions and other computer-readable program code portions that can be executed to control processors of the components of program action orchestration operation server 210 to implement various operations, including the examples shown herein. As such, a series of computer-readable program code portions may be embodied in one or more computer program products and can be used, with a device, program action orchestration operation server 210, database, and/or other programmable apparatus, to produce the machine-implemented processes discussed herein. It is also noted that all or some of the information discussed herein can be based on data that is received, generated and/or maintained by one or more components of the program action orchestration operation server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of program action orchestration operation server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

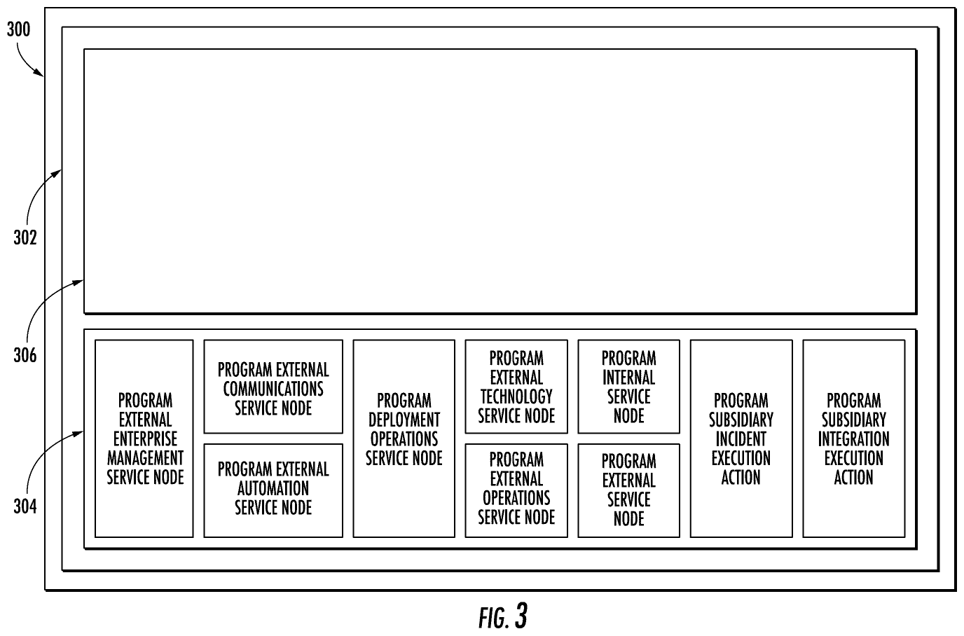

In various embodiments of the present disclosure, an apparatus (e.g., the program action orchestration operation server 210) may be configured to generate, output, manage, and/or cause rendering of a program configuration selection interface component of a program action orchestration operation system 200. For example, an apparatus (e.g., the program action orchestration operation server 210) may be configured to output and/or cause rendering of a program configuration selection interface component on a program management interface 300 of the program action orchestration operation system 200. FIG. 3 illustrates an example program configuration selection interface component 302 structured in accordance with various embodiments of the present disclosure. In some embodiments, the apparatus (e.g., program action orchestration operation server 210) causes rendering of the program configuration selection interface component 302 to a visual display of a computing device (e.g., a client device 101A-101N).

In some embodiments, the program configuration selection interface component 302 may be configured to display a program configuration selection item interface component 304 and/or a program configuration selection action interface component 306. In this regard, for example, the program configuration selection item interface component 304 and/or the program configuration selection action interface component 306 may be configured to be rendered to, or as a portion of, the program configuration selection interface component 302.

In some embodiments, the program configuration selection item interface component 304 may be configured to display one or more program subsidiary execution actions, such as one or more program subsidiary incident execution actions and/or program subsidiary integration execution actions. Additionally, or alternatively, in some embodiments, the program configuration selection item interface component 304 may be configured to display one or more program external service nodes and/or program internal service nodes. In some embodiments, the program configuration selection item interface component 304 may be configured with drag and drop functionality. In this regard, for example, the program configuration selection item interface component 304 may be configured such that a user associated with the program configuration selection item interface component 304 may drag one or more program subsidiary execution actions, program external service nodes, and/or program internal service nodes from the program configuration selection item interface component 304 to another interface component (e.g., the program configuration selection action interface component 306). In this regard, for example, the program configuration selection item interface component 304 may be configured to at least partially generate and/or identify configured program orchestration data based at least in part on unconfigured program orchestration data.

In some embodiments, the program configuration selection action interface component 306 may be configured to display one or more program subsidiary execution actions, such as one or more program subsidiary incident execution actions and/or program subsidiary integration execution actions. Additionally, or alternatively, in some embodiments, program configuration selection action interface component 306 may be configured to display one or more program external service nodes and/or program internal service nodes. In some embodiments, program configuration selection action interface component 306 may be configured with drag and drop functionality. In this regard, for example, program configuration selection action interface component 306 may be configured such that a user associated with program configuration selection action interface component 306 may drag one or more program subsidiary execution actions, program external service nodes, and/or program internal service nodes from another interface component (e.g., the program configuration selection item interface component 304) to program configuration selection action interface component 306. In this regard, for example, program configuration selection action interface component 306 may be configured to at least partially generate and/or identify configured program orchestration data based at least in part on unconfigured program orchestration data.

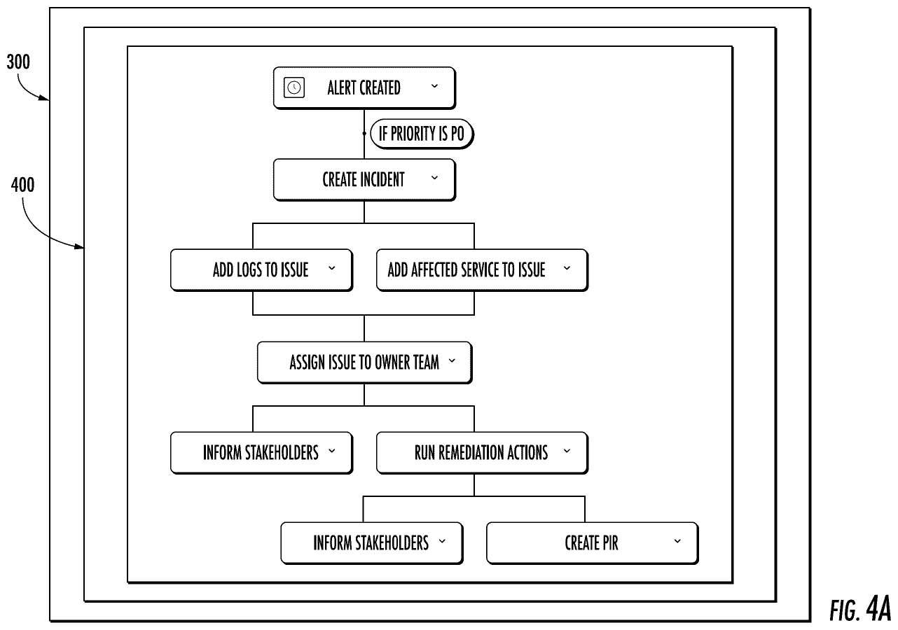

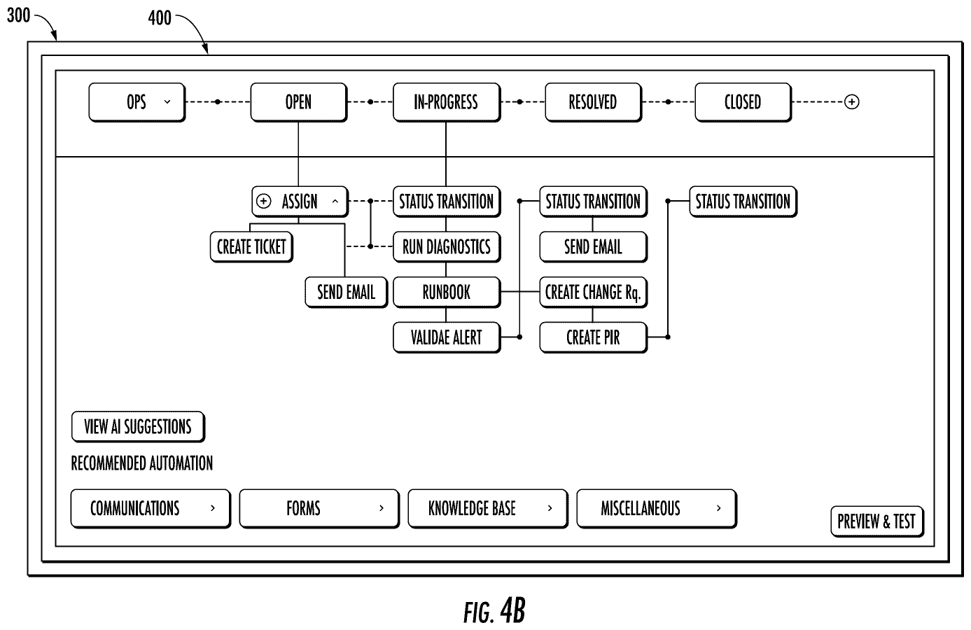

In various embodiments of the present disclosure, an apparatus (e.g., the program action orchestration operation server 210) may be configured to generate, output, manage, and/or cause rendering of a configured program orchestration visualization interface component of a program action orchestration operation system 200. For example, an apparatus (e.g., the program action orchestration operation server 210) may be configured to output and/or cause rendering of a configured program orchestration visualization interface component on a program management interface 300 of the program action orchestration operation system 200. FIG. 4A and FIG. 4B illustrate an example configured program orchestration visualization interface component 400 structured in accordance with various embodiments of the present disclosure. For example, FIG. 4A illustrates a first version of the configured program orchestration visualization interface component 400 and 4B illustrates a second version of the configured program orchestration visualization interface component 400. In some embodiments, the apparatus (e.g., program action orchestration operation server 210) causes rendering of the configured program orchestration visualization interface component 400 to a visual display of a computing device (e.g., a client device 101A-101N).

In some embodiments, the configured program orchestration visualization interface component 400 may be configured to display configured program orchestration data. In some embodiments, a configured program orchestration visualization interface component may be based at least in part on configured program orchestration data.

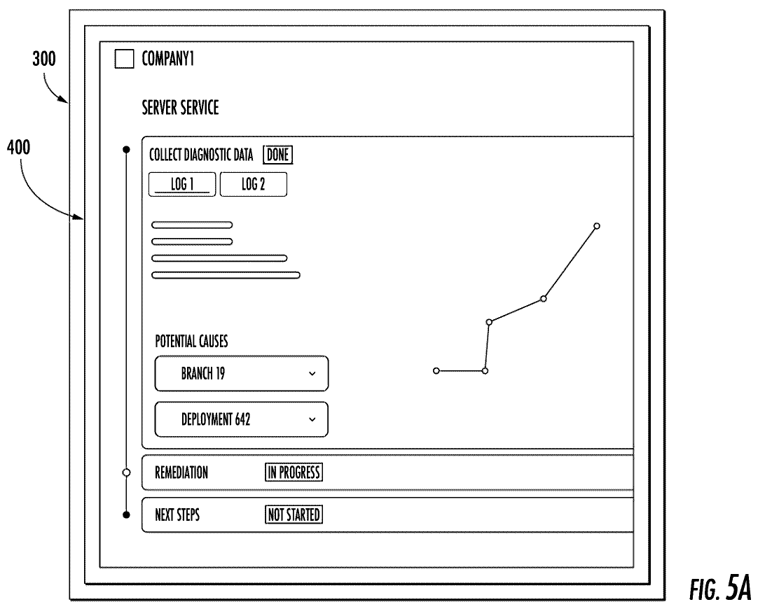

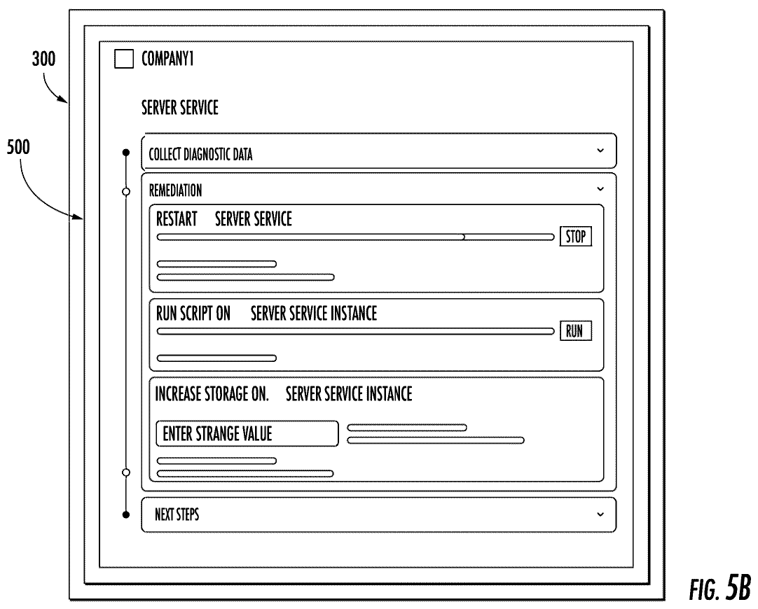

In various embodiments of the present disclosure, an apparatus (e.g., the program action orchestration operation server 210) may be configured to generate, output, manage, and/or cause rendering of a program subsidiary execution action status interface component of a program action orchestration operation system 200. For example, an apparatus (e.g., the program action orchestration operation server 210) may be configured to output and/or cause rendering of a program subsidiary execution action status interface component on a program management interface 300 of the program action orchestration operation system 200. FIG. 5 illustrates an example program subsidiary execution action status interface component 500 structured in accordance with various embodiments of the present disclosure. For example, FIG. 5A illustrates a first version of the program subsidiary execution action status interface component 500 and 5B illustrates a second version of the program subsidiary execution action status interface component 500. In some embodiments, the apparatus (e.g., program action orchestration operation server 210) causes rendering of the program subsidiary execution action status interface component 500 to a visual display of a computing device (e.g., a client device 101A-101N).

In some embodiments, the program subsidiary execution action status interface component 500 may be configured to display the status of one or more program subsidiary execution actions. For example, a program subsidiary execution action status interface component may be configured to display completed program subsidiary execution actions, in progress program subsidiary execution actions, and/or program subsidiary execution actions that have yet to be initiated. In some embodiments, a program subsidiary execution action status interface component may be generated based at least in part on one or more program subsidiary execution actions.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to output and/or provide a program management interface, a program configuration selection interface component, a program configuration selection item interface component, a program configuration selection action interface component, a configured program orchestration visualization interface component, a program subsidiary execution action status interface component, and/or the like in a program action orchestration operation system 200 in a number of ways. Additionally, or alternatively, it will further be appreciated that the example apparatuses, systems, devices, and/or computer program products may proceed to generate and/or initiate, for example using an automated program subsidiary execution action engine 230, performance of one or more program subsidiary execution actions and/or the like in a program action orchestration operation system 200 in a number of ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

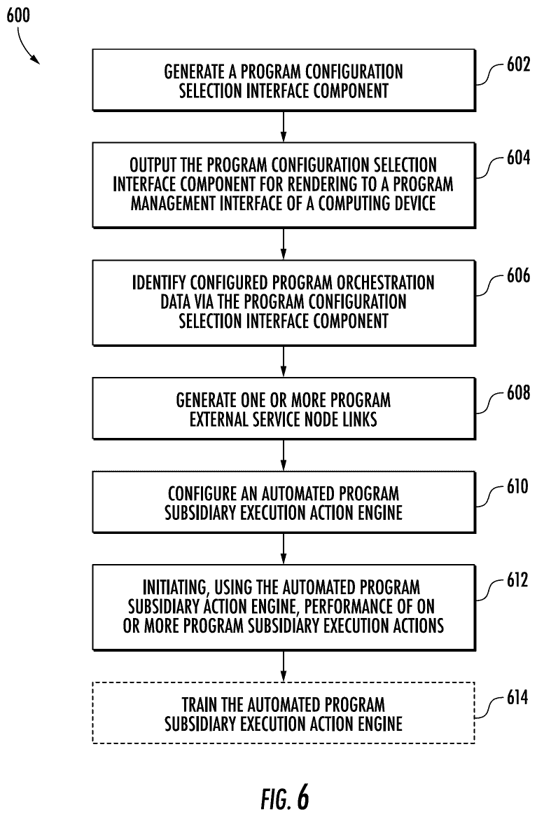

FIG. 6 is a flowchart broadly illustrating a series of operations or process blocks that are executed or performed to initiating performance of one or more program subsidiary execution actions in accordance with some example embodiments of the present disclosure. In some embodiments, the method 600 is embodied by computer program code stored on a non-transitory computer-readable storage medium of a computer program product configured for execution to perform the process as depicted and described. In this regard, in some such embodiments, the program action orchestration operation server 210 is specially configured by computer-coded instructions (e.g., computer program instructions) stored thereon, for example in the memory 201 and/or another component depicted and/or described herein and/or otherwise accessible to the program action orchestration operation server 210, for performing the operations as depicted and described. Alternatively, or additionally, in some embodiments, the method 600 is performed by one or more specially configured computing devices, such as the program action orchestration operation server 210 alone or in communication with one or more other component(s), device(s), system(s), and/or the like. For example, in some embodiments, the program action orchestration operation server 210 is in communication with one or more external apparatus(es), system(s), device(s), and/or the like, to perform one or more of the operations as depicted and described. For purposes of simplifying the description, the method 600 is described as performed by and from the perspective of the program action orchestration operation server 210. In this regard, performance of the operations may invoke one or more of memory 201, processor 202, input/output circuitry 203, communications circuitry 204, and/or program action orchestration operation circuitry 205.

In the embodiment illustrated in FIG. 6, the flowchart illustrates method 600 which begins at block 602. At block 602, the program action orchestration operation server 210 includes means, such as the memory 201, processor 202, input/output circuitry 203, communications circuitry 204, and/or program action orchestration operation circuitry 205, or a combination thereof, to generate a program configuration selection interface component based at least in part on unconfigured program orchestration data. In some embodiments, unconfigured program orchestration data may include one or more items of data indicative and/or representative of one or more program subsidiary execution actions, program internal service nodes, and/or program external service nodes.

At block 604, the program action orchestration operation server 210 includes means, such as the memory 201, processor 202, input/output circuitry 203, communications circuitry 204, and/or program action orchestration operation circuitry 205, or a combination thereof, to output the program configuration selection interface component for rendering to a program management interface of a computing device. In some embodiments, the program management interface may be a graphical user interface of a program action orchestration operation server that is configured to enable one or more users to view and engage with one or more program action orchestration operation system workspaces, views, and/or interface components.

At block 606, the program action orchestration operation server 210 includes means, such as the memory 201, processor 202, input/output circuitry 203, communications circuitry 204, and/or program action orchestration operation circuitry 205, or a combination thereof, to identify configured program orchestration data. In some embodiments, configured program orchestration data may be identified via at least the program configuration selection interface component.

In some embodiments, configured program orchestration data may be one or more items of data indicative and/or representative of one or more program subsidiary execution actions, program internal service nodes, and/or program external service nodes configured in an ordered combination. In some embodiments, configured program orchestration data may be one or more items of data indicative and/or representative of one or more program subsidiary execution actions, program internal service nodes, and/or program external service nodes configured in an ordered combination that is associated with an objective, project, and/or the like of an enterprise. In some embodiments, configured program orchestration data may be stored in a program action orchestration operation data repository.

At block 608, the program action orchestration operation server 210 includes means, such as the memory 201, processor 202, input/output circuitry 203, communications circuitry 204, and/or program action orchestration operation circuitry 205, or a combination thereof, to generate one or more program external service node links. In some embodiments, program external service node links may be generated based at least in part on the configured program orchestration data.

In some embodiments, a program external service node link may be a data object that enables communication between a program action orchestration operation system and a program external service node. In some embodiments, a program external service node link may be a data object enables communication between a program action orchestration operation system and a program external service node such that a program external service node may assist in performing one or more program subsidiary execution actions. For example, a program external service node link may be a data object that enables communication between a program action orchestration operation system and a program external service node such that a program external service node may assist in performing one or more program subsidiary incident execution actions and/or program subsidiary integration execution actions. In some embodiments, a program external service node link may be one or more of a program external technology service node link, program external enterprise management service node link, program external operations service node link, program external communications service node link, program external automation service node link, and/or a program external deployment service node link.

At block 610, the program action orchestration operation server 210 includes means, such as the memory 201, processor 202, input/output circuitry 203, communications circuitry 204, and/or program action orchestration operation circuitry 205, or a combination thereof, to configure an automated program subsidiary execution action engine 230. In some embodiments, the automated program subsidiary execution action engine 230 may be configured based at least in part on the configured program orchestration data. Additionally, or alternatively, the automated program subsidiary execution action engine 230 may be configured based at least in part on one or more program external service node links.

In some embodiments, the automated program subsidiary execution action engine 230 may be a software application configured to at least in part initiate performance of one or more program subsidiary execution actions. For example, an automated program subsidiary execution action engine 230 may be a software application configured to at least in part initiate performance of one or more program subsidiary incident execution actions and/or program subsidiary integration execution actions. In some embodiments, an automated program subsidiary execution action engine 230 may be configured based at least in part on configured program orchestration data and/or program external service node links. In this regard, an automated program subsidiary execution action engine 230 may be a software application configured to at least in part initiate performance of one or more program subsidiary execution actions based at least in part on configured program orchestration data and/or program external service node links.

At block 612, the program action orchestration operation server 210 includes means, such as the memory 201, processor 202, input/output circuitry 203, communications circuitry 204, and/or program action orchestration operation circuitry 205, or a combination thereof, to initiate performance of one or more program subsidiary execution actions. In some embodiments, performance of program subsidiary actions may be initiated using the automated program subsidiary execution action engine 230. In some embodiments, a program subsidiary execution action may include an actionable item, work item, issue, and/or task that may be performed by a program action orchestration operation server and/or a user associated with a program action orchestration operation server. In some embodiments, a program subsidiary execution action may include a program subsidiary incident execution action and/or a program subsidiary integration execution action.

In some embodiments, a program subsidiary incident execution action may be an incident actionable item, incident work item, incident issue, and/or incident task that may be performed by a program action orchestration operation server and/or a user associated with a program action orchestration operation server. For example, a program subsidiary incident execution action may include performing a portal request. As another example, a program subsidiary incident execution action may include performing data monitoring.

As another example, a program subsidiary incident execution action may include analyzing a historical log. As another example, a program subsidiary incident execution action may include validating an incident alert. As another example, a program subsidiary incident execution action may include generating incident alert documentation. As another example, a program subsidiary incident execution action may include identifying services affected by an incident. As another example, a program subsidiary incident execution action may include generating and/or assigning a ticket. As another example, a program subsidiary incident execution action may include transmitting an incident notification.

As another example, a program subsidiary incident execution action may include performing incident diagnostics. As another example, a program subsidiary incident execution action may include generating an incident resolution. As another example, a program subsidiary incident execution action may include performing incident resolution validation. As another example, a program subsidiary incident execution action may include notifying affected services of incident resolution. As another example, a program subsidiary incident execution action may include generating incident cause documentation. As another example, a program subsidiary incident execution action may include generating incident resolution documentation.

In some embodiments, a program subsidiary integration execution action may be an integration actionable item, integration work item, integration issue, and/or integration task that may be performed by a program action orchestration operation server and/or a user associated with a program action orchestration operation server. For example, a program subsidiary integration execution action may include generating user integration documentation. As another example, a program subsidiary integration execution action may include generating a user integration ticket.

As another example, a program subsidiary integration execution action may include generating a user account. As another example, a program subsidiary integration execution action may include selecting user software. As another example, a program subsidiary integration execution action may include generating facilities access documentation. As another example, a program subsidiary integration execution action may include generating facilities workstation setup documentation. As another example, a program subsidiary integration execution action may include generating user workstation items documentation. As another example, a program subsidiary integration execution action may include associating a user with procurement. As another example, a program subsidiary integration execution action may include associating a user with relevant team members.

In some embodiments, a program subsidiary execution action may be performed using a program internal service node. In some embodiments, a program internal service node may include one or more data processing services internal to the program action orchestration operation system configured to assist in performing one or more program subsidiary execution actions. For example, a program internal service node may be one or more data processing services internal to the program action orchestration operation system configured to assist in performing one or more program subsidiary integration execution actions and/or program subsidiary incident execution actions. Additionally, or alternatively, a program subsidiary execution action may be performed using a program external service node. In some embodiments, a program external service node may include one or more data processing services external to the program action orchestration operation system configured to assist in performing one or more program subsidiary execution actions. For example, a program external service node may be one or more data processing services external to the program action orchestration operation system configured to assist in performing one or more program subsidiary integration execution actions and/or program subsidiary incident execution actions. In some embodiments, a program external service node may include one or more program external technology service nodes, program external enterprise management service nodes, program external operations service nodes, program external communications service nodes, program external automation service nodes, and/or program external deployment service nodes.

In some embodiments, initiating performance of one or more program subsidiary execution actions may include initiating a first program subsidiary execution action, determining that the first program subsidiary execution action is complete, and initiating a second program subsidiary execution action in response to the determination that the first program subsidiary execution action is complete. For example, initiating performance of one or more program subsidiary execution actions may include initiating a program subsidiary execution action in response to determining that another program subsidiary execution action has been completed.

In some embodiments, initiating performance of one or more program subsidiary execution actions may include identifying a first program subsidiary execution action associated with an execution delay time period, determining that the execution delay time period has occurred, and initiating the first program subsidiary execution action in response to the determination that the execution delay time period has occurred. In some embodiments, an execution delay time period may be a timeboxed period, time interval, and/or unit of time that occurs before a program subsidiary execution action is initiated. For example, initiating performance of one or more program subsidiary execution actions may include initiating a program subsidiary execution action in response to a determination that an execution delay time period has occurred.

In some embodiments, initiating performance of one or more program subsidiary execution actions may include initiating a first program subsidiary execution action, identifying program subsidiary execution action input data, and initiating a second program subsidiary execution action in response to the identification of the program subsidiary execution action input data. In some embodiments, program subsidiary execution action input data may be one or more items of data representative of and/or associated with information associated with initiating performance of a program subsidiary execution action. For example, a program action orchestration operation system may be configured to initiate a program subsidiary execution action based at least in part on identifying program subsidiary execution action input data. In some embodiments, program subsidiary execution action input data may be provided to a program action orchestration operation system by a user, such as via an interface. For example, initiating performance of one or more program subsidiary execution actions may include initiating a program subsidiary execution action in response to identifying program subsidiary execution action input data.

In some embodiments, initiating performance of one or more program subsidiary execution actions may include initiating a first program subsidiary execution action that is associated with program subsidiary execution occurrence time period and initiating a second program subsidiary execution action during the program subsidiary execution occurrence time period. In some embodiments, a program subsidiary execution occurrence time period may be a timeboxed period, time interval, and/or unit of time in which at least two program subsidiary execution actions are initiated. For example, a program action orchestration operation system may be configured to initiate a first program subsidiary execution action and a second program subsidiary execution action during a program subsidiary execution occurrence time period. For example, initiating performance of one or more program subsidiary execution actions may include initiating one or more program subsidiary execution actions in parallel.

In some embodiments, initiating performance of one or more program subsidiary execution actions may include initiating a first program subsidiary execution action, determining that the first program subsidiary execution action failed, and reinitiating the first program subsidiary execution action in response to the determination that the first program subsidiary execution failed. For example, initiating performance of one or more program subsidiary execution actions may include reinitiating a program subsidiary execution action if the program subsidiary execution action failed to complete when previously initiated.

In some embodiments, initiating performance of one or more program subsidiary execution actions may include identifying a first program subsidiary execution action and a second program subsidiary execution action and generating a third program subsidiary execution action based at least in part on the first program subsidiary execution action and the second program subsidiary execution action. For example, initiating performance of one or more program subsidiary execution actions may include combining two program subsidiary execution actions into one program subsidiary execution action.

In some embodiments, initiating performance of one or more program subsidiary execution actions may include initiating a first program subsidiary action to generating a program subsidiary execution action executable configured to initiate performance of one or more other program subsidiary execution actions. In some embodiments, a program subsidiary execution action executable may be computer program code that is executed and/or executable by a program action orchestration operation system to initiate performance of one or more program subsidiary execution actions. For example, initiating performance of one or more program subsidiary execution actions may include generating a program subsidiary execution action executable and using the program subsidiary execution action executable to initiating other program subsidiary execution actions.

At optional block 614, the program action orchestration operation server 210 includes means, such as the memory 201, processor 202, input/output circuitry 203, communications circuitry 204, and/or program action orchestration operation circuitry 205, or a combination thereof, to train the automated program subsidiary execution action engine 230. In some embodiments, an automated program subsidiary execution action engine 230 may be configured to be trained based at least in part on aggregated configured program orchestration data. In some embodiments, an automated program subsidiary execution action may include a machine learning model. In this regard, for example, a machine learning model of an automated program subsidiary execution action engine 230 may be configured to be trained using aggregated configured program orchestration data. In some embodiments, an automated program subsidiary execution action engine 230 may be executed and/or used by a program action orchestration operation system (e.g., a program action orchestration operation server) to initiate performance of one or more program subsidiary execution actions.

In some embodiments, aggregated configured program orchestration data may be one or more items of data indicative and/or representative of an aggregation of historical program subsidiary execution actions, historical program internal service nodes, and/or historical program external service nodes configured in an ordered combination. In some embodiments, aggregated configured program orchestration data may be one or more items of data indicative and/or representative of an aggregation of historical program subsidiary execution actions, historical program internal service nodes, and/or historical program external service nodes configured in an ordered combination that is associated with an historical objective, historical project, and/or the like of an enterprise. In some embodiments, aggregated configured program orchestration data may be used to train an automated program subsidiary execution action engine 230.

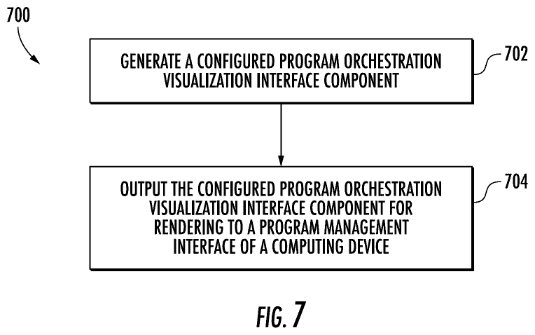

FIG. 7 is a flowchart broadly illustrating a series of operations or process blocks that are executed or performed to output a configured program orchestration visualization interface component for rendering to a program management interface of a computing device in accordance with some example embodiments of the present disclosure. In some embodiments, the method 700 is embodied by computer program code stored on a non-transitory computer-readable storage medium of a computer program product configured for execution to perform the process as depicted and described. In this regard, in some such embodiments, the program action orchestration operation server 210 is specially configured by computer-coded instructions (e.g., computer program instructions) stored thereon, for example in the memory 201 and/or another component depicted and/or described herein and/or otherwise accessible to the program action orchestration operation server 210, for performing the operations as depicted and described. Alternatively, or additionally, in some embodiments, the method 700 is performed by one or more specially configured computing devices, such as the program action orchestration operation server 210 alone or in communication with one or more other component(s), device(s), system(s), and/or the like. For example, in some embodiments, the program action orchestration operation server 210 is in communication with one or more external apparatus(es), system(s), device(s), and/or the like, to perform one or more of the operations as depicted and described. For purposes of simplifying the description, the method 700 is described as performed by and from the perspective of the program action orchestration operation server 210. In this regard, performance of the operations may invoke one or more of memory 201, processor 202, input/output circuitry 203, communications circuitry 204, and/or program action orchestration operation circuitry 205.

In the embodiment illustrated in FIG. 7, the flowchart illustrates method 700 which begins at block 702. At block 702, the program action orchestration operation server 210 includes means, such as the memory 201, processor 202, input/output circuitry 203, communications circuitry 204, and/or program action orchestration operation circuitry 205, or a combination thereof, to generate a configured program orchestration visualization interface component. In some embodiments, a configured program orchestration visualization interface component may be generated based at least in part on configured program orchestration data.

At block 704, the program action orchestration operation server 210 includes means, such as the memory 201, processor 202, input/output circuitry 203, communications circuitry 204, and/or program action orchestration operation circuitry 205, or a combination thereof, to output the configured program orchestration visualization interface component for rendering to a program management interface of a computing device.

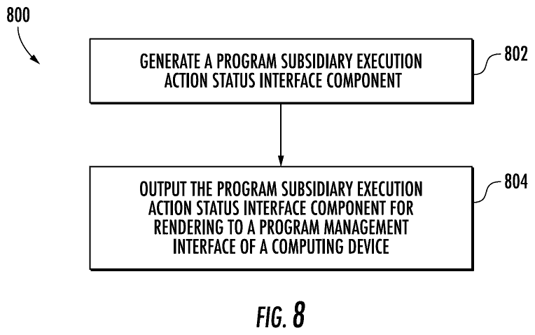

FIG. 8 is a flowchart broadly illustrating a series of operations or process blocks that are executed or performed to output a program subsidiary execution action status interface component for rendering to a program management interface of a computing device in accordance with some example embodiments of the present disclosure. In some embodiments, the method 800 is embodied by computer program code stored on a non-transitory computer-readable storage medium of a computer program product configured for execution to perform the process as depicted and described. In this regard, in some such embodiments, the program action orchestration operation server 210 is specially configured by computer-coded instructions (e.g., computer program instructions) stored thereon, for example in the memory 201 and/or another component depicted and/or described herein and/or otherwise accessible to the program action orchestration operation server 210, for performing the operations as depicted and described. Alternatively, or additionally, in some embodiments, the method 800 is performed by one or more specially configured computing devices, such as the program action orchestration operation server 210 alone or in communication with one or more other component(s), device(s), system(s), and/or the like. For example, in some embodiments, the program action orchestration operation server 210 is in communication with one or more external apparatus(es), system(s), device(s), and/or the like, to perform one or more of the operations as depicted and described. For purposes of simplifying the description, the method 800 is described as performed by and from the perspective of the program action orchestration operation server 210. In this regard, performance of the operations may invoke one or more of memory 201, processor 202, input/output circuitry 203, communications circuitry 204, and/or program action orchestration operation circuitry 205.

In the embodiment illustrated in FIG. 8, the flowchart illustrates method 800 which begins at block 802. At block 802, the program action orchestration operation server 210 includes means, such as the memory 201, processor 202, input/output circuitry 203, communications circuitry 204, and/or program action orchestration operation circuitry 205, or a combination thereof, to generate a program subsidiary execution action status interface component. In some embodiments, a program subsidiary execution action status interface component may be generated based at least in part on program subsidiary execution actions.

At block 804, the program action orchestration operation server 210 includes means, such as the memory 201, processor 202, input/output circuitry 203, communications circuitry 204, and/or program action orchestration operation circuitry 205, or a combination thereof, to output the program subsidiary execution action status interface component for rendering to a program management interface of a computing device.

FIGS. 6, 7, and 8 thus illustrate flowcharts describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the program action orchestration operation server 210 and executed by a processor 202 of the program action orchestration operation server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for initiating performance of one or more program subsidiary execution actions, the apparatus comprising at least one processor, and at least one memory including program code, the at least one memory and the program code configured to, with the at least one processor, cause the apparatus to at least:
generate a program configuration selection interface component based at least in part on unconfigured program orchestration data;
output the program configuration selection interface component for rendering to a program management interface of a computing device;
identify configured program orchestration data via the program configuration selection interface component;
generate one or more program external service node links based at least in part on the configured program orchestration data;
configure an automated program subsidiary execution action engine based at least in part on the configured program orchestration data and one or more of the one or more program external service node links; and
initiate, using the automated program subsidiary execution action engine, performance of one or more program subsidiary execution actions.

2. The apparatus of claim 1, wherein initiating performance of the one or more program subsidiary execution actions comprises the program code being further configured to, with the at least one processor, further cause the apparatus to:
initiate a first program subsidiary execution action;
determine that the first program subsidiary execution action is complete; and
initiate a second program subsidiary execution action in response to the determination that the first program subsidiary execution action is complete.

3. The apparatus of claim 1, wherein initiating performance of the one or more program subsidiary execution actions comprises the program code being further configured to, with the at least one processor, further cause the apparatus to:
identify a first program subsidiary execution action, wherein the first program subsidiary execution action is associated with an execution delay time period;
determine that the execution delay time period has occurred; and
initiate the first program subsidiary execution action in response to the determination that the execution delay time period has occurred.

4. The apparatus of claim 1, wherein initiating performance of the one or more program subsidiary execution actions comprises the program code being further configured to, with the at least one processor, further cause the apparatus to:
identify a first program subsidiary execution action, wherein the first program subsidiary execution action is associated with an execution delay program event;
determine that the execution delay program event has occurred; and
initiate the first program subsidiary execution action in response to the determination that the execution delay program event has occurred.

5. The apparatus of claim 1, wherein initiating performance of the one or more program subsidiary execution actions comprises the program code being further configured to, with the at least one processor, further cause the apparatus to:
initiate a first program subsidiary execution action;
identify program subsidiary execution action input data; and
initiate a second program subsidiary execution action in response to the identification of the program subsidiary execution action input data.

6. The apparatus of claim 1, wherein initiating performance of the one or more program subsidiary execution actions comprises the program code being further configured to, with the at least one processor, further cause the apparatus to:
initiate a first program subsidiary execution action, wherein the first program subsidiary execution action is associated with a program subsidiary execution occurrence time period; and
initiate a second program subsidiary execution action, wherein the second program subsidiary execution action is initiated during the program subsidiary execution occurrence time period.

7. The apparatus of claim 1, wherein initiating performance of the one or more program subsidiary execution actions comprises the program code being further configured to, with the at least one processor, further cause the apparatus to:
initiate a first program subsidiary execution action;
determine that the first program subsidiary execution action failed; and
reinitiate the first program subsidiary execution action in response to the determination that the first program subsidiary execution action failed.

8. The apparatus of claim 1, wherein initiating performance of the one or more program subsidiary execution actions comprises the program code being further configured to, with the at least one processor, further cause the apparatus to:
initiate a first program subsidiary execution action, wherein initiating the first program subsidiary execution action comprises:
identifying a first program subsidiary execution action and a second program subsidiary execution action; and
generating a third program subsidiary execution action based at least in part on the first program subsidiary execution action and the second program subsidiary execution action.

9. The apparatus of claim 1, wherein initiating performance of the one or more program subsidiary execution actions comprises the program code being further configured to, with the at least one processor, further cause the apparatus to:
initiate a first program subsidiary execution action, wherein initiating the first program subsidiary execution action comprises:
generating a program subsidiary execution action executable configured to initiate performance of one or more other program subsidiary execution actions.

10. The apparatus of claim 1, wherein the program code is further configured to, with the at least one processor, cause the apparatus to:
train the automated program subsidiary execution action engine based at least in part on aggregated configured program orchestration data.

11. The apparatus of claim 1, wherein the one or more program external service node links comprise one or more of a program external technology service node link, a program external enterprise management service node link, a program external operations service node link, a program external communications service node link, a program external automation service node link, or a program external deployment service node link.

12. The apparatus of claim 1, wherein the one or more program subsidiary execution actions comprise a program subsidiary incident execution action.

13. The apparatus of claim 1, wherein the one or more program subsidiary execution actions comprise a program subsidiary integration execution action.

14. The apparatus of claim 1, wherein the program code is further configured to, with the at least one processor, cause the apparatus to:
generate a configured program orchestration visualization interface component based at least in part on the configured program orchestration data; and
output the configured program orchestration visualization interface component for rendering to the program management interface of the computing device.

15. The apparatus of claim 1, wherein the program code is further configured to, with the at least one processor, cause the apparatus to:
generate a program subsidiary execution action status interface component based at least in part on the one or more program subsidiary execution actions; and
output the program subsidiary execution action status interface component for rendering to the program management interface of the computing device.

16. A method for initiating performance of one or more program subsidiary execution actions, the method comprising:
generating a program configuration selection interface component based at least in part on unconfigured program orchestration data;
outputting the program configuration selection interface component for rendering to a program management interface of a computing device;
identifying configured program orchestration data via the program configuration selection interface component;
generating one or more program external service node links based at least in part on the configured program orchestration data;
configuring an automated program subsidiary execution action engine based at least in part on the configured program orchestration data and one or more of the one or more program external service node links; and
initiating, using the automated program subsidiary execution action engine, performance of one or more program subsidiary execution actions.

17. The method of claim 16, wherein initiating performance of the one or more program subsidiary execution actions comprises:
initiating a first program subsidiary execution action;
determining that the first program subsidiary execution action is complete; and
initiating a second program subsidiary execution action in response to the determination that the first program subsidiary execution action is complete.

18. The method of claim 16, wherein initiating performance of the one or more program subsidiary execution actions comprises:
identifying a first program subsidiary execution action, wherein the first program subsidiary execution action is associated with an execution delay time period;
determining that the execution delay time period has occurred; and
initiating the first program subsidiary execution action in response to the determination that the execution delay time period has occurred.

19. The method of claim 16, wherein initiating performance of the one or more program subsidiary execution actions comprises:
identifying a first program subsidiary execution action, wherein the first program subsidiary execution action is associated with an execution delay program event;
determining that the execution delay program event has occurred; and
initiating the first program subsidiary execution action in response to the determination that the execution delay program event has occurred.

20. A computer program product for initiating performance of one or more program subsidiary execution actions, the computer program product comprising at least one non-transitory computer-readable storage medium having computer-readable program code portions stored therein, the computer-readable program code portions comprising an executable portion configured to:
generate a program configuration selection interface component based at least in part on unconfigured program orchestration data;
output the program configuration selection interface component for rendering to a program management interface of a computing device;
identify configured program orchestration data via the program configuration selection interface component;
generate one or more program external service node links based at least in part on the configured program orchestration data;
configure an automated program subsidiary execution action engine based at least in part on the configured program orchestration data and one or more of the one or more program external service node links; and
initiate, using the automated program subsidiary execution action engine, performance of one or more program subsidiary execution actions.
